(19) United States
(12) Patent Application Publication
(10) Pub. No.: US 2018/0149793 A1
(43) Pub. Date: May 31, 2018

(54) GLASS ARTICLES COMPRISING LIGHT EXTRACTION FEATURES AND METHODS FOR MAKING THE SAME

(71) Applicant: CORNING INCORPORATED, CORNING, NY (US)

(72) Inventors: Jacques Gollier, Redmond, WA (US); Tian Huang, Painted Post, NY (US)

(21) Appl. No.: 15/575,009

(22) PCT Filed: May 17, 2016
(86) PCT No.: PCT/US16/32864

§ 371 Date: Nov. 17, 2017

Related U.S. Application Data
(60) Provisional application No. 62/163,133, filed on May 18, 2015.

(51) Int. Cl. F21V 8/00; C03C 15/00; C03C 23/00

(52) U.S. Cl. CPC G02B 6/0036; C03C 23/0025; C03C 15/00; G02B 6/0065

(57) ABSTRACT

Disclosed herein are glass article, such as light guide plates, comprising a first surface, an opposing second surface, and a thickness extending therebetween; wherein and at least one of the first or second surface is patterned with a plurality of light extraction features having a diameter ranging from about 5 microns to about 1 mm and a depth ranging from about 1 micron to about 3 mm. Glass articles disclosed herein can have improved uniformity of light extraction features, such as a distribution of light extraction efficiency with a 1σ value of less than or equal to 0.4. Display devices comprising such glass articles are also disclosed herein as well as methods for producing such glass articles.

### CROSS-REFERENCE TO RELATED APPLICATIONS

This application claims the benefit of priority under 35 U.S.C. § 119 of U.S. Provisional Application Ser. No. 62/163133 filed on May 18, 2015, the content of which is relied upon and incorporated herein by reference in its entirety.

### FIELD OF THE DISCLOSURE

The disclosure relates generally to glass articles and display devices comprising such glass articles, and more particularly to glass light guides comprising light extraction features and methods for making the same by laser damaging and etching.

### BACKGROUND

Liquid crystal displays (LCDs) are commonly used in various electronics, such as cell phones, laptops, electronic tablets, televisions, and computer monitors. Increased demand for larger, high-resolution flat panel displays drives the need for large high-quality glass substrates for use in the display. For example, glass substrates may be used as light guide plates (LGPs) in LCDs, to which a light source may be coupled. A common LCD configuration for thinner displays includes a light source optically coupled to an edge of the light guide. Light guide plates are often equipped with light extraction features on one or more surfaces to scatter light as it travels along the length of the light guide, thereby causing a portion of the light to escape the light guide and project toward the viewer. Engineering of such light extraction features to improve homogeneity of light scattering along the length of the light guide has been studied in an effort to generate higher quality projected images.

Currently, light guide plates can be constructed from plastic materials having high transmission properties, such as polymethyl methacrylate (PMMA) or methyl methacrylate styrene (MS). However, due to their relatively weak mechanical strength, it can be difficult to make light guides from PMMA or MS that are both sufficiently large and thin to meet current consumer demands. Plastic light guides may also necessitate a larger gap between the light source and guide due to low coefficients of thermal expansion, which can reduce optical coupling efficiency and/or require a larger display bezel. Glass light guides have been proposed as alternatives to plastic light guides due to their low light attenuation, low coefficient of thermal expansion, and high mechanical strength. Methods for providing light extraction features on plastic materials can include, for example, injection molding and laser damaging to produce light extraction features. While these techniques may work well with plastic light guides, injection molding and laser damaging can be incompatible with glass light guides. In particular, laser exposure may jeopardize glass reliability, e.g., may promote chipping, crack propagation, and/or sheet rupture.

In addition, laser damaging may produce extraction features that are too small to efficiently extract light from the light guide plate. Increasing the density of such small features may be possible but can increase the length of processing and, thus, the cost and/or time for production. Moreover, laser damaging of glass can create debris and/or defects around the extraction features. Such debris and defects can increase light extraction but, due to their inhomogeneity, may create high-frequency noise that can lead to image artifacts or defects (“mura”). Defects having various shapes and/or sizes can also create wavelength-dependent scattering, which can drive undesirable color shifting. Furthermore, the addition of energy to the glass sheet via laser can instigate various chemical reactions, which can generate gaseous products that redeposit on the surface of the glass sheet. These deposits and/or chemical changes in the vicinity of light extraction features can also generate color shift and/or create high-frequency noise.

Alternative methods for applying light extraction features to glass light guides can include printing techniques such screen printing or inkjet printing. Specifically, inkjet or screen printing can be used to create patterns on the light guide with white or scattering ink. However, printing light extraction features on glass may present other challenges. For example, the ink itself may absorb some of the light and generate a color shift. Accordingly, it would be advantageous to provide glass articles, such as light guide plates, for display devices which address the aforementioned drawbacks, e.g., glass light guide plates having light extraction features which provide enhanced image quality and reduced color shifting and/or high-frequency noise.

### SUMMARY

The disclosure relates, in various embodiments, to glass articles, such as light guide plates, comprising a first surface and an opposing second surface, wherein the first surface comprises a plurality of concave light extraction features having a diameter ranging from about 5 microns to about 1 mm and a depth ranging from about 1 micron to about 3 mm, and wherein a distribution of light extraction efficiency of the plurality of concave light extraction features has a 1σ value of at least about 0.4. Display devices comprising such glass articles are further disclosed herein. In certain embodiments, the diameter of the light extraction features can range from about 20 microns to about 50 microns and the depth can range from about 10 microns to about 200 microns. According to various embodiments, the concave light extraction features can be ellipsoidal, paraboloidal, hyperboloidal, or frusto-conical. In a further embodiment, the plurality of concave light extraction features may be present on the first surface in a random, arranged, repetitive, non-repetitive, symmetrical, or asymmetrical pattern.

Methods for making such glass articles or light guide plates are also disclosed, the methods comprising contacting a first surface of a glass substrate with a laser to produce a first plurality of light extraction features having a first diameter and a first depth; and etching the glass substrate to form a second plurality of concave light extraction features having a second diameter and a second depth. In various embodiments, the second depth and/or diameter can be greater than the first depth and/or diameter. According to additional embodiments, the second diameter can range from about 20 microns to about 50 microns and the second depth can range from about 20 microns to about 200 microns. In further embodiments, the laser may be chosen from CO₂ lasers, yttrium aluminum garnet (YAG) lasers, frequency tripled neodymium-doped YAG (Nd:YAG) lasers, and frequency tripled neodymium-doped yttrium orthovanadate (Nd:YVO4) lasers. According to yet further embodiments, etching the glass substrate can comprise contacting the substrate with at least one etching agent, e.g., immersing the substrate in an acid bath.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings, wherein, when possible, like numerals refer to like components, it being understood that the appended figures are not necessarily drawn to scale.

FIG. 1A illustrates a glass article comprising a plurality of light extraction features according to embodiments of the disclosure;

FIG. 1B illustrates a glass article comprising a plurality of light-extracting ink features;

FIG. 2 illustrates the surface of a glass article comprising light extraction features produced by laser damaging;

FIG. 3 is a schematic illustrating a method for making a glass article according to various embodiments of the disclosure;

FIG. 4A is an image of a light extraction feature produced by laser damaging;

FIG. 4B is an image of a light extraction feature produced by laser damaging followed by etching according to certain embodiments of the disclosure;

FIG. 5A is a side view of a glass article comprising light extraction features produced by laser damaging;

FIG. 5B is a side view of a glass article comprising light extraction features produced by laser damaging followed by etching according to various embodiments of the disclosure;

FIG. 5C is a side view of a glass article comprising light extraction features produced by laser damaging;

FIG. 5D is a side view of a glass article comprising light extraction features produced by laser damaging followed by etching according to certain embodiments of the disclosure;

FIGS. 6A-B illustrate the surface of glass articles comprising light extraction features produced by laser damaging followed by etching according to various embodiments of the disclosure;

FIG. 7A illustrates the surface of a glass articles comprising light extraction features produced by laser damaging; and

FIG. 7B illustrates the surface of a glass article comprising light extraction features produced by laser damaging followed by etching according to certain embodiments of the disclosure.

### DETAILED DESCRIPTION

### Glass Articles

Disclosed herein are glass articles comprising a first surface and an opposing second surface, wherein the first surface comprises a plurality of concave light extraction features having a diameter ranging from about 5 microns to about 1 mm and a depth ranging from about 1 micron to about 3 mm, and wherein a distribution of light extraction efficiency of the plurality of concave light extraction features has a 1σ value of at least about 0.4. Exemplary glass articles can include, but are not limited to, glass light guide plates. Display devices comprising such glass articles are further disclosed herein.

The glass article or light guide plate may comprise any material known in the art for use in displays and other similar devices including, but not limited to, aluminosilicate, alkali-aluminosilicate, borosilicate, alkali-borosilicate, aluminoborosilicate, alkali-aluminoborosilicate, soda lime, and other suitable glasses. In certain embodiments, the glass article may have a thickness of less than or equal to about 3 mm, for example, ranging from about 0.3 mm to about 2 mm, from about 0.7 mm to about 1.5 mm, or from about 1.5 mm to about 2.5 mm, including all ranges and subranges therebetween. Non-limiting examples of commercially available glasses suitable for use as a light guide plate include, for instance, EAGLE XG®, Gorilla®, Iris™, Lotus™, and Willow® glasses from Corning Incorporated.

The glass article may comprise a first surface and an opposing second surface. The surfaces may, in certain embodiments, be planar or substantially planar, e.g., substantially flat and/or level. The first and second surfaces may, in various embodiments, be parallel or substantially parallel. The glass article may further comprise at least one side edge, for instance, at least two side edges, at least three side edges, or at least four side edges. By way of a non-limiting example, the glass article may comprise a rectangular or square glass sheet having four edges, although other shapes and configurations are envisioned and are intended to fall within the scope of the disclosure. The glass sheet may, for example, be substantially flat or planar, or may be curved around one or more axes.

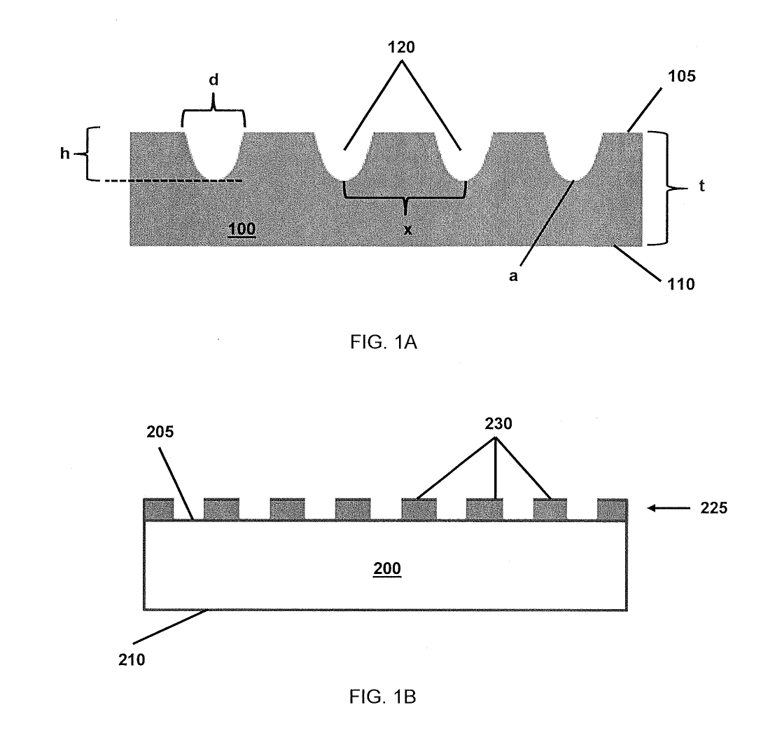

As shown in FIG. 1A, the glass article 100, e.g., glass light guide, can comprise a first surface 105, a second surface 110, and a plurality of light extraction features 120. A thickness t of the glass article 100 extends between the first and second surfaces. While the plurality of light extraction features 220 is illustrated in FIG. 1A as present on the first surface 105, it is to be understood that these orientations and labels can be switched without limitation, the surfaces being referred to herein as “first” and “second” solely for the purposes of discussion. Moreover, it is possible, in non-limiting embodiments, for both surfaces of the glass article to comprise light extraction features. For example, the first surface may be provided with light extraction features according to the methods disclosed herein and the opposing second surface may be provided with light extraction features by the same or different methods known in the art. When both surfaces comprise light extraction features, the features can be identical or different in size, shape, spacing, geometry, and so on, without limitation.

As depicted in FIG. 1A, the light extraction features 120 can be concave features. As used herein, the term “concave” is intended to denote a light extraction feature whose surface curves downward below the surrounding surface of the glass article, e.g., a semi-spherical or semi-ellipsoidal shape. The light extraction feature can be envisioned as a rounded crater positioned on the surface of the glass article, the dimensions of which need not be perfectly rounded, semi-spherical, or semi-ellipsoidal. For example, the light extraction features 120 may be ellipsoidal, paraboloidal, hyperboloidal, frusto-conical, or can have any other suitable geometry.

FIG. 1B depicts a comparative glass article 200 coated with a layer of ink 225, which is patterned on the first surface 205 of the glass article to create light-extracting ink features 230. As compared to the light-extracting ink features 230 of FIG. 1B, which are raised above the first surface 205 of the glass article 200, the light extraction features 120 of FIG. 1A are located below the first surface 105 of the glass article 100. Moreover, the light-extracting ink features 230 of FIG. 1B have a shape conforming to and positioned on the first surface 205 of the glass article 200, e.g., substantially planar (not concave), whereas the light extraction features 120 of FIG. 1A have a rounded shape curving downward below the surrounding surface of the glass article 100.

Referring to FIG. 1A, the plurality of light extraction features 120 can have a diameter d and a depth h. In some embodiments, light extraction features 120 can have a diameter d ranging from about 5 microns to about 1 mm, such as from about 5 microns to about 500 microns, from about 10 microns to about 400 microns, from about 20 microns to about 300 microns, from about 30 microns to about 250 microns, from about 40 microns to about 200 microns, from about 50 microns to about 150 microns, from about 60 microns to about 120 microns, from about 70 microns to about 100 microns, or from about 80 microns to about 90 microns, including all ranges and subranges therebetween. According to various embodiments, the diameter d of each light extraction feature can be identical to or different from the diameter d of other light extraction features in the plurality.

The depth h of the light extraction features 120 can range, for example, from about 1 micron to about 3 mm, such as from about 5 microns to about 2 mm, from about 10 microns to about 1.5 mm, from about 20 microns to about 1 mm, from about 30 microns to about 0.7 mm, from about 40 microns to about 0.5 mm, from about 50 microns to about 0.4 mm, from about 60 microns to about 0.3 mm, from about 70 microns to about 0.2 mm, or from about 80 microns to about 0.1 mm, including all ranges and subranges therebetween. According to various embodiments, the depth h of each light extraction feature can be identical to or different from the depth h of other light extraction features in the plurality of light extraction features 120.

As illustrated in FIG. 1A, the depth h of the plurality of light extraction features 120 can be less than the thickness t of the glass article 100. In certain embodiments, the depth h can be substantially equal to the thickness t of the glass article (e.g., a light extraction feature extending from the first surface to the second surface through the thickness of the article). In yet further embodiments, the ratio t:h can range from about 100:1 to about 1:1, such as from about 50:1 to about 2:1, from about 25:1 to about 3:1, from about 20:1 to about 4:1, or from about 10:1 to about 5:1, including all ranges and subranges therebetween. In some embodiments the ratio h:d can range from about 100:1 to about 1:1, such as from about 50:1 to about 2:1, from about 25:1 to about 3:1, from about 20:1 to about 4:1, or from about 10:1 to about 5:1, including all ranges and subranges therebetween. Of course, the ratios t:h and h:d can vary from feature to feature in the plurality without limitation.

The light extraction features 120 can have an apex a (or lowest point in the feature), and the distance x between light extraction features can be defined as the distance between the apexes of two adjacent light extraction features. According to various embodiments, the distance x can range from about 5 microns to about 2 mm, such as from about 10 microns to about 1.5 mm, from about 20 microns to about 1 mm, from about 30 microns to about 0.5 mm, or from about 50 microns to about 0.1 mm, including all ranges and subranges therebetween. It is to be understood that the distance x between each light extraction feature can vary in the plurality of light extraction features 120, with different extraction features spaced apart from one another at varying distances x. Although FIG. 1A depicts a plurality of evenly spaced-apart light extraction features 120 in a substantially regular line or pattern, it is to be understood that the plurality of features can be patterned on the glass surface in any given pattern or design, which may, for example, be random or arranged, repetitive or non-repetitive, symmetrical or asymmetrical.

According to various embodiments, light extraction features 120 on some portions of the glass article 100 (e.g., a glass light guide plate) may have a diameter d, depth h, spacing x, ratio t:h, and/or ratio h:d, while light extraction features 120 on other portions of the glass article 100 may have a second diameter d, depth h, spacing x, ratio t:h, and/or ratio h:d. For example, light extraction features 120 on portions of the glass article 100 (such as a light guide plate) adjacent or near the edges thereof or adjacent or near portions that receive light from a source (not shown) may have a first diameter d, depth h, spacing x, ratio t:h, and/or ratio h:d, and light extraction features 120 near the center of the glass article 100 or a predetermined distance from the light source may have a second diameter d, depth h, spacing x, ratio t:h, and/or ratio h:d. In other embodiments, diameters, depths, ratios, and/or geometries of the light extraction features 120 may vary as a function of position on the surface of the glass article 100.

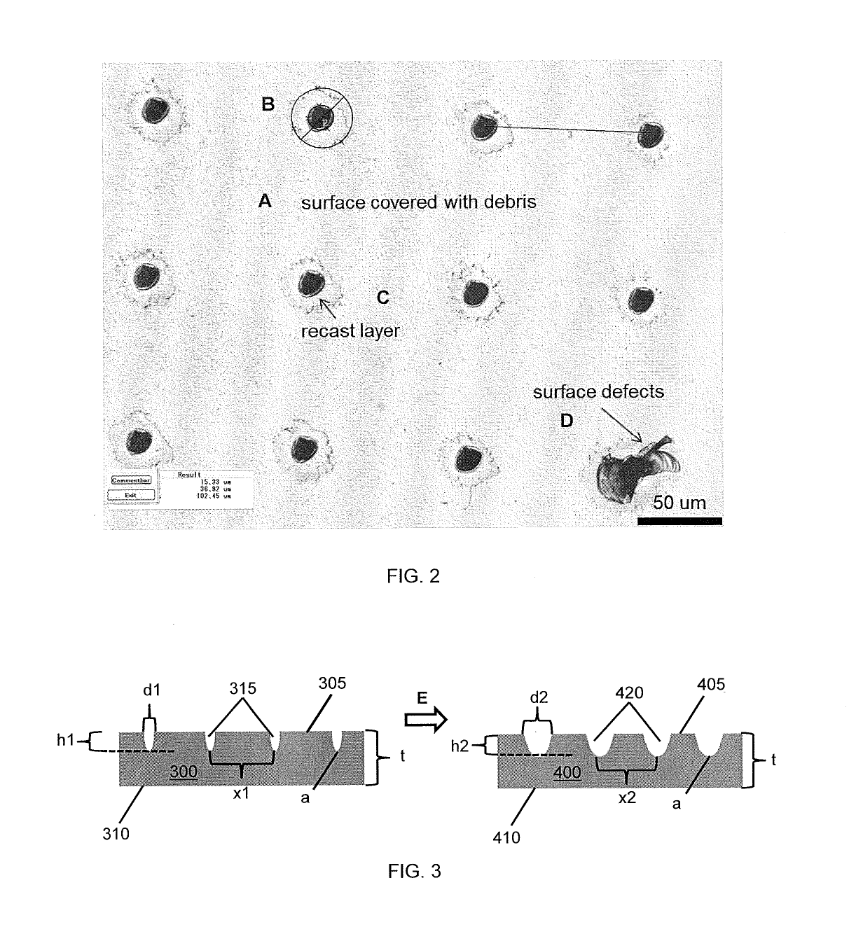

FIG. 2 illustrates the surface of a glass article comprising light extraction features (dark indentations) produced by laser damaging (30 pulses with Nd:YVO4 laser at 5 KHz frequency). It should be noted that while FIG. 2 illustrates light extraction features in an array of rows and columns, this should not limit the scope of the claims appended herewith as exemplary light extraction features can be generated in repetitive or non-repetitive, random or arranged, symmetrical or asymmetrical manner. Generally speaking, it can be observed that the individual extraction features each have a slightly different shape and/or size from other features in the plurality. In region A, debris from the laser damaging process can be observed on the surface in the vicinity of the features (black specks). In region B, a light feature is depicted as surrounded by defects (debris, recast, damage, etc.). The outer diameter or “splatter zone” (estimated by the circumscribed circle) is significantly larger than the diameter of the extraction feature itself. Moreover, this area is different in shape and/or size from other similarly positioned outer regions around the other features in the plurality of light extraction features. In region C, a recast layer is depicted around a light extraction feature. Recast layers can comprise, for example, re-deposited glass materials and/or reaction products adhered to the glass surface. In region D, surface defects, such as chips and/or cracks in the glass surface, are illustrated. Other defects or flaws that may exist but cannot be readily viewed in FIG. 2 include, but are not limited to, heat-modified zones around the features where the glass material is thermally modified and/or subsurface microcracks formed due to the thermal shock and/or shockwave endured during a laser patterning process. All of these surface/subsurface features, whether visible or not, can affect the performance of the glass article, e.g., the light extraction efficiency, color shift, and/or mura of the glass article. Superficial cleaning may remove a portion of the debris from the surface, but may not alter or remove certain surface or subsurface defects.

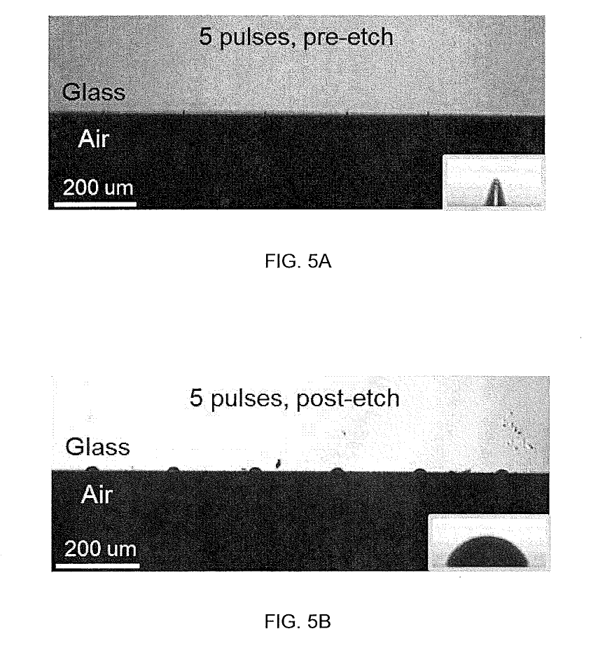

In contrast to the depiction of light extraction features in FIG. 2, exemplary embodiments having laser processing followed by etching can produce a plurality of light extraction features having improved uniformity, e.g., in terms of shape and/or size of the features and/or reduced debris and/or defects on the surface and/or subsurface of the glass article (see, e.g., FIGS. 4B, 5B, 5D, 6A, 6B, and 7B). According to some embodiments, the plurality of light extraction features can have a narrow diameter distribution, e.g., the plurality can have an average diameter d_{avg} and the number of individual features having a diameter greater than or less than one standard deviation (1σ) from this value is less than about 20%, such as less than about 10%, less than about 5%, less than about 3%, less than about 2%, or less than about 1%, including all ranges and subranges therebetween. Uniformity can also be described in terms of intensity or light extraction efficiency. For instance, the plurality of features can have an average extraction efficiency e_{avg} (measured, e.g., in terms of watts of light extracted) and the number of individual features having an efficiency greater than or less than one standard deviation (1σ) of this value can be less than about 20%, such as less than about 10%, less than about 5%, less than about 3%, less than about 2%, or less than about 1%, including all ranges and subranges therebetween. In other words, for the diameter distribution and/or light extraction efficiency distribution of the plurality of light extraction features, 1σ is at least about 0.4, such as at least about 0.41, 0.42, 0.43, 0.44, 0.45, 0.46, 0.47, 0.48, or 0.49, including all ranges and subranges therebetween. As used herein, the 1σ value is intended to denote the percentage of individual light extraction features falling within (below or above) one standard deviation of the mean value. Thus for a 1σ extraction efficiency value of 0.4, 80% of features can have an extraction efficiency falling within one standard deviation of the average extraction efficiency (e.g., 40% of features can have an extraction efficiency less than the average and 40% of features can have an extraction efficiency greater than the average), and 20% of features can have an extraction efficiency falling outside of this standard deviation range. For sake of brevity, these exemplary embodiments are described in further detail below under the methods section of this disclosure.

The glass articles and light guide plates disclosed herein may be used in various display devices including, but not limited to LCDs or other displays used in the television, advertising, automotive, and other industries. Traditional backlight units used in LCDs can comprise various components. One or more light sources may be used, for example light-emitting diodes (LEDs) or cold cathode fluorescent lamps (CCFLs). Conventional LCDs may employ LEDs or CCFLs packaged with color converting phosphors to produce white light. According to various aspects of the disclosure, display devices employing the disclosed glass articles may comprise at least one light source emitting blue light (UV light, approximately 100-400 nm), such as near-UV light (approximately 300-400 nm). The light guide plates and devices disclosed herein may also be used in any suitable lighting applications such as, but not limited to, luminaires or the like. In some embodiments, the glass articles can be used as a light guide in display devices, such as LCDs, and a light source, e.g., LED, can be optically coupled to at least one edge of the light guide.

As used herein, the term “optically coupled” is intended to denote that a light source is positioned at an edge of the glass article so as to introduce light into the guide. When light is injected into the glass article, e.g. glass light guide plate, according to certain embodiments, the light is trapped and bounces within the light guide due to total internal reflection (TIR) until it hits a light extraction feature on the first or second surface. As used herein, the term “light-emitting surface” is intended to denote a surface from which light is emitted from the light guide plate toward a viewer. For instance, the first or second surface can be a light-emitting surface. Similarly, the term “light-incident surface” is intended to denote a surface that is coupled to a light source, e.g., an LED, such that light enters the light guide. For example, the side edge of the light guide plate can be a light-incident surface.

### Methods

Disclosed herein are methods for making glass articles or light guide plates, the methods comprising contacting a first surface of a glass substrate with a laser to produce a first plurality of intermediate light extraction features having a first diameter and a first depth; and etching the glass substrate to form a second plurality of concave light extraction features having a second diameter and a second depth.

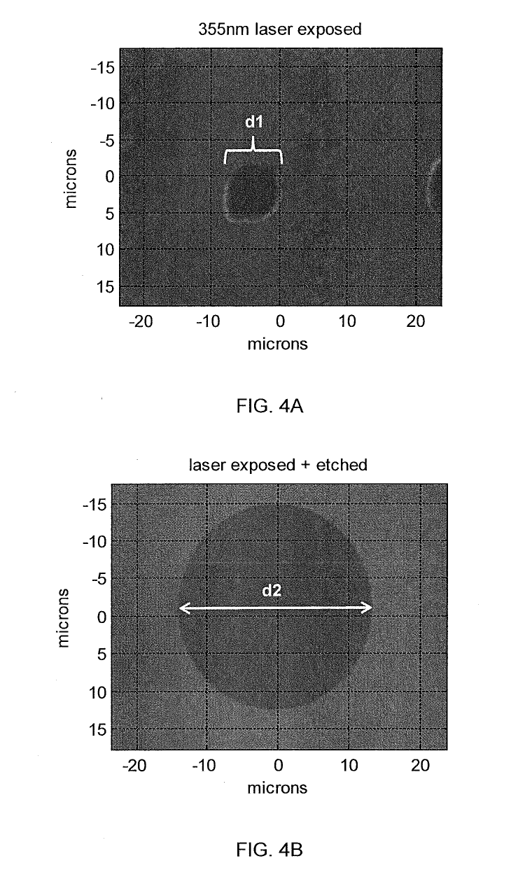

Methods for making the glass articles disclosed herein will be discussed, without limitation, with reference to FIG. 3. A glass substrate 300 can be provided having a first surface 305, an opposing second surface 310, and a thickness t extending therebetween. The first or second surface of the glass sheet can be contacted with a laser, for example, by moving a laser along a predetermined path on the surface of a stationary glass sheet. Alternatively, the laser may be stationary and the glass sheet can be moved along the predetermined path. The predetermined path can be a line or a plurality of lines; however, other predetermined paths, including non-linear paths are envisioned. Moreover, more than one predetermined path can be traced on the surface to form a more complex pattern, which can be repetitive or non-repetitive, random or arranged, symmetrical or asymmetrical.

Contact with the laser, e.g., a CO₂ laser, UV laser, or the like, can comprise single laser pulses along the predetermined path, or multiple pulses can be used to increase the depth and/or width of the features. The pulses can have, for example, a duration (or pulse width) of less than a second, less than 0.5 seconds, less than 0.1 seconds, less than 0.01 seconds, less than a nanosecond, or less than a picosecond. In some embodiments, the pulse width can range from about 10 nanoseconds to about 100 nanoseconds, such as from about 20 nanoseconds to about 90 nanoseconds, from about 30 nanoseconds to about 80 nanoseconds, from about 40 nanoseconds to about 70 nanoseconds, or from about 50 nanoseconds to about 60 nanoseconds, including all ranges and subranges therebetween. The dimension of the light extraction features (e.g., diameter and/or depth) can be controlled, e.g., by varying the number of pulse repetitions in a given location. According to various embodiments, the light extraction features can be deepened and/or widened at a rate of about 0.5 microns to about 3 microns per laser pulse, such as from about 1 micron to about 2.5 microns per laser pulse, or from about 1.5 microns to 2 microns per laser pulse, including all ranges and subranges therebetween. The number of pulses repeated for a give location can range, for example, from 1 to 100 pulses, such as from 2 to 90 pulses, from 3 to 80 pulses, from 5 to 70 pulses, from 10 to 60 pulses, from 20 to 50 pulses, or from 30 to 40 pulses, including all ranges and subranges therebetween.

The pulse repetition rate (or frequency) can range, for example, from about 1 kHz to about 150 kHz, such as from about 5 kHz to about 125 kHz, from about 10 kHz to about 100 kHz, from about 20 kHz to about 90 kHz, from about 30 kHz to about 80 kHz, from about 40 kHz to about 70 kHz, of from about 50 kHz to about 60 kHz, including all ranges and subranges therebetween. In additional embodiments, the pulse energy can range from about 10 μJ to about 200 μJ, such as from about 20 μJ to about 150 μJ, from about 30 μJ to about 120 μJ, from about 40 μJ to about 100 μJ, from about 50 μJ to about 90 μJ, or from about 60 μJ to about 80 μJ, including all ranges and subranges therebetween.

Non-limiting exemplary methods and lasers suitable for laser damaging and cutting glass are disclosed, for instance, in U.S. application Ser. Nos. 13/989,914; 14/092,536; 14/145,525; 14/530,457; 14/535,800; 14/535,754; 14/530,379; 14/529,801; 14/529,520; 14/529,697; 14/536,009; 14/530,410; and 14/530,244; and International Application Nos. PCT/EP14/055364; PCT/US15/130019; and PCT/US15/13026; all of which are incorporated herein by reference in their entireties. Lasers can operate at any wavelength suitable for damaging the surface of the glass substrate, such as UV (˜100-400 nm), visible (˜400-700 nm), and infrared (˜700 nm-1 mm) wavelengths. In some embodiments, the laser wavelength can range from about 200 nm to about 10 microns, such as from about 300 nm to about 5 microns, from about 400 nm to about 4 microns, from about 500 nm to about 3 microns, or from about 1 micron to about 2 microns, including all ranges and subranges therebetween.

A suitable laser damaging technique can include, for example, a CO₂ laser damaging technique, which utilizes a CO₂ laser to quickly heat the glass to a temperature at, near, or above the glass strain point. CO₂ lasers can operate, for example, at wavelengths greater than about 1 micron, such as about 1.06 microns. In other embodiments, a UV laser can be used, such as a frequency tripled neodymium-doped yttrium aluminum garnet (Nd:YAG) or frequency tripled neodymium-doped yttrium orthovanadate (Nd:YVO4) lasers operating at a wavelength of about 355 nm. Alternatively, a YAG laser operating at 1064 nm can also be used. Rapid laser heating can, in some embodiments, be followed by a rapid quenching process using, e.g., a solid water or water mist jet.

Irradiation of the glass substrate 300 with the laser along the predetermined path on the first or second surface can create a plurality of light extraction features 315 having a diameter d1 and a depth h1. These extraction features 315 (pre-etching) can be interchangeably referred to herein as “intermediate” extraction features or a “first” plurality of light extraction features. The laser contact time and/or laser strength can be chosen to achieve the desired optical properties for the light guide. In some embodiments, the diameter d1 can range from about 1 micron to about 300 microns, such as from about 5 microns to about 250 microns, from about 10 microns to about 200 microns, from about 20 microns to about 150 microns, from about 30 microns to about 100 microns, from about 40 microns to about 90 microns, from about 50 microns to about 80 microns, or from about 60 microns to about 70 microns, including all ranges and subranges therebetween. According to various embodiments, the diameter d1 of each intermediate light extraction feature can be identical to or different from the diameter d1 of other intermediate light extraction features in the plurality.

With reference to FIG. 3, the laser can modify the glass substrate along a predetermined path to create intermediate light extraction features 315 having any desired depth h1. For example, the depth h1 can range from about 1 micron to about 3 mm, such as from about 5 microns to about 2 mm, from about 10 microns to about 1.5 mm, from about 20 microns to about 1 mm, from about 30 microns to about 0.7 mm, from about 40 microns to about 0.5 mm, from about 50 microns to about 0.4 mm, from about 60 microns to about 0.3 mm, from about 70 microns to about 0.2 mm, or from about 80 microns to about 0.1 mm, including all ranges and subranges therebetween. As illustrated in FIG. 3, the depth h1 of the plurality of light extraction features 315 can be less than the thickness t of the glass sheet. According to various embodiments, the depth h1 of each intermediate light extraction feature can be identical to or different from the depth h1 of other intermediate light extraction features in the plurality.

In certain embodiments, the depth h1 can be substantially equal to the thickness t of the glass substrate (e.g., a light extraction feature extending from the first surface to the second surface through the thickness of the substrate). In yet further embodiments, the ratio t:h1 can range from about 100:1 to about 1:1, such as from about 50:1 to about 2:1, from about 25:1 to about 3:1, from about 20:1 to about 4:1, or from about 10:1 to about 5:1, including all ranges and subranges therebetween. In some embodiments the ratio h1:d1 can range from about 100:1 to about 1:1, such as from about 50:1 to about 2:1, from about 25:1 to about 3:1, from about 20:1 to about 4:1, or from about 10:1 to about 5:1, including all ranges and subranges therebetween.

The light extraction features can have an apex a (or lowest point in the feature), and the distance x1 between light extraction features can be defined as the distance between the apexes of two adjacent light extraction features. According to various embodiments, the distance x1 can range from about 5 microns to about 2 mm, such as from about 10 microns to about 1.5 mm, from about 20 microns to about 1 mm, from about 30 microns to about 0.5 mm, or from about 50 microns to about 0.1 mm, including all ranges and subranges therebetween. It is to be understood that the distance x1 between each light extraction feature can vary in the plurality, with different intermediate extraction features spaced apart from one another at varying distances x1.

As shown in FIG. 3, after contact with the laser, the glass substrate 300 comprising a plurality of intermediate light extraction features 315 can be subjected to an etching step E. Etching can be carried out using any process known in the art, for example, by immersion in or contact with an etching agent. According to various embodiments, the etching step can comprise immersing the glass substrate in an acid bath, such as hydrofluoric acid (HF) and/or hydrochloric acid (HCl) or any other suitable mineral or inorganic acid, e.g., nitric acid (HNO₃), sulfuric acid (HSO₄), and the like. Suitable concentrations for the acid bath can range, for example from about 0.2 M to about 2 M, such as from about 0.4 M to about 1.8 M, from about 0.6 M to about 1.6 M, from about 0.8 M to about 1.4 M, or from about 1 M to about 1.2 M, including all ranges and subranges therebetween. According to various embodiments, the etching agent may be chosen from agents that do not create high-frequency textures on the surface of the glass article. For example, organic etching agents can create insoluble crystals on the surface of the glass substrate, which can produce high-frequency textures on the surface of the glass substrate and which may drive color shifting. Thus, in some embodiments, the etching agent may not be chosen from organic etching agents, e.g., acetic acid and the like.

The glass substrate 300 comprising a plurality of light extraction features 315 can be etched for a time sufficient to create glass article 400 comprising first surface 405, second surface 410, thickness t, and light extraction features 420. These extraction features 420 can be interchangeably referred to herein as “post-etch” extraction features or a “second” plurality of light extraction features. The etching time may range, for example, from about 30 seconds to about 15 minutes, such as from about 1 minute to about 10 minutes, from about 2 minutes to about 8 minutes, or from about 3 minutes to about 5 minutes, including all ranges and subranges therebetween, and the etching may take place at room temperature or at elevated temperature. Etching, e.g., in an acid bath, can take place with or without mechanical agitation and/or bath circulation. Additionally, ultrasonic energy can be applied to the bath to provide a more uniform etching rate. Exemplary suitable etching techniques include the etching processes are also described in co-pending U.S. patent application Ser. Nos. 13/541,206 and 14/591,456, the entirety of each being incorporated herein by reference.

Process parameters such as acid concentration/ratio, temperature, and/or time may affect the size, shape, and distribution of the resulting extraction features. For instance, more concentrated etching solutions and/or longer etching times, to name a few parameters, may affect the amount of glass dissolved during the etching step and, thus, the depth h2 and/or diameter d2 of the resulting light extraction features 420. Average etching rates can range, for instance, from about 0.1 micron per minute to about 10 microns per minute, such as from about 0.5 microns per minute to about 5 microns per minute, from about 1 micron per minute to about 4 microns per minute, or from about 2 microns per minute to about 3 microns per minute, including all ranges and subranges therebetween. It is within the ability of one skilled in the art to vary these parameters to achieve the desired surface extraction features.

In some embodiments, post-etch light extraction features 420 can have a diameter d2 ranging from about 5 microns to about 1 mm, such as from about 5 microns to about 500 microns, from about 10 microns to about 400 microns, from about 20 microns to about 300 microns, from about 30 microns to about 250 microns, from about 40 microns to about 200 microns, from about 50 microns to about 150 microns, from about 60 microns to about 120 microns, from about 70 microns to about 100 microns, or from about 80 microns to about 90 microns, including all ranges and subranges therebetween. According to various embodiments, the diameter d2 of each light extraction feature can be identical to or different from the diameter d2 of other light extraction features in the plurality. In further embodiments, the diameter d2 of the light extraction features 420 can be larger than the diameter d1 of the light extraction features 315. For example, d2 can be at least about 10% larger than dl, such as at least about 20%, 30%, 40%, 50%, 60%, 70%, 80%, 90%, 100%, 200%, 300%, 400%, or 500% larger than d1. According to certain embodiments, d2 can be about twice as large as d1, such as about 2, 3, 4, 5, 6, 7, 8, 9, or 10 times larger than d1. The etching process described above can be modified to provide or achieve a desired or predetermined geometry, diameter, etc., to remove any irregularities encountered during laser damaging, or to achieve a suitable or more preferred final geometry, diameter, etc. for optimal light extraction.

With continued reference to FIG. 3, the etching step can create light extraction features 420 having any desired depth h2. For example, the depth h2 can range from about 1 micron to about 3 mm, such as from about 5 microns to about 2 mm, from about 10 microns to about 1.5 mm, from about 20 microns to about 1 mm, from about 30 microns to about 0.7 mm, from about 40 microns to about 0.5 mm, from about 50 microns to about 0.4 mm, from about 60 microns to about 0.3 mm, from about 70 microns to about 0.2 mm, or from about 80 microns to about 0.1 mm, including all ranges and subranges therebetween. As illustrated in FIG. 3, the depth h2 of the plurality of light extraction features 420 can be less than the thickness t of the glass article 400. In certain embodiments, the depth h2 of the light extraction features 420 can be larger than the depth h1 of the light extraction features 315. For example, h2 can be at least about 10% larger than h1, such as at least about 20%, 30%, 40%, 50%, 60%, 70%, 80%, 90%, 100%, 200%, 300%, 400%, or 500% larger than h1. In other embodiments, as illustrated in FIG. 3, depth h2 can be substantially equal to depth h1 (e.g., within about 10% of h1). According to various embodiments, the depth h2 of each light extraction feature can be identical to or different from the depth h2 of other light extraction features in the plurality of extraction features. The etching process described above can be modified to provide or achieve a desired or predetermined geometry, depth, etc. to remove any irregularities encountered during laser damaging or to achieve a suitable or more preferred final geometry, diameter, etc. for optimal light extraction.

In certain embodiments, the depth h2 can be substantially equal to the thickness t of the glass article (e.g., a light extraction feature extending from the first surface to the second surface through the thickness of the article). In yet further embodiments, the ratio t:h2 can range from about 100:1 to about 1:1, such as from about 50:1 to about 2:1, from about 25:1 to about 3:1, from about 20:1 to about 4:1, or from about 10:1 to about 5:1, including all ranges and subranges therebetween. In some embodiments the ratio h2:d2 can range from about 100:1 to about 1:1, such as from about 50:1 to about 2:1, from about 25:1 to about 3:1, from about 20:1 to about 4:1, or from about 10:1 to about 5:1, including all ranges and subranges therebetween. Of course, the ratios t:h2 and h2:d2 can vary from feature to feature in the plurality without limitation. Again, the etching process described above can be modified to provide or achieve a desired or predetermined geometry, diameter/depth/thickness ratio, etc. to remove any irregularities encountered during laser damaging or to achieve a suitable or more preferred final geometry, diameter/depth/thickness ratio, etc. for optimal light extraction.

The light extraction features can have an apex a (or lowest point in the feature), and the distance x2 between light extraction features can be defined as the distance between the apexes of two adjacent light extraction features. According to various embodiments, the distance x2 can range from about 5 microns to about 2 mm, such as from about 10 microns to about 1.5 mm, from about 20 microns to about 1 mm, from about 30 microns to about 0.5 mm, or from about 50 microns to about 0.1 mm, including all ranges and subranges therebetween. In certain embodiments, the distance x2 between light extraction features 420 can be substantially identical to or different from the distance x1 between the light extraction features 315. It is to be understood that the distance x2 between each light extraction feature can vary in the plurality, with different extraction features spaced apart from one another at varying distances x2.

According to various embodiments, light extraction features 420 on glass article 400 can have similar shape, size, spacing, and/or geometry as light extraction features 120 of glass article 100 (see FIG. 1A), for example, d=d2; h=h2; x=x2; t:h=t:h2; h:d=h2:d2; and so on, without limitation. As with glass article 100, some portions of the glass article 400 (e.g., a glass light guide plate) may have a diameter d2, depth h2, spacing x2, ratio t:h2, and/or ratio h2:d2, while light extraction features 420 on other portions of the glass article 400 may have a second diameter d2, depth h2, spacing x2, ratio t:h2, and/or ratio h2:d2. For example, light extraction features 420 on portions of the glass article 400 (such as a light guide plate) adjacent or near the edges thereof or adjacent or near portions that receive light from a source (not shown) may have a first diameter d2, depth h2, spacing x2, ratio t:h2, and/or ratio h2:d2, and light extraction features 420 near the center of the glass article 400 or a predetermined distance from the light source may have a second diameter d2, depth h2, spacing x2, ratio t:h2, and/or ratio h2:d2. In other embodiments, depth, diameters, ratios, and/or geometries of the light extraction features 420 may vary as a function of position on the surface of the glass article 400.

FIG. 4A depicts a single light extraction feature formed in a glass substrate using a Nd:YVO4 laser operating at 355 nm, the feature having a diameter d1 of about 10 microns. A slightly irregular shape can be observed, as well as a ring of debris (white) around the perimeter of the feature. FIG. 4B depicts the same light extraction feature after acid etching. The feature has a diameter d2 of about 30 microns. A more rounded shape can be observed, as well as the absence of noticeable debris around the perimeter of the feature.

The methods disclosed herein can be used to pattern the first and/or second surface of the glass article with a plurality of light extraction features. As used herein, the term “patterned” is intended to denote that the plurality of features are present on the surface of the glass article in any given pattern or design, which may, for example, be random or arranged, repetitive or non-repetitive, symmetrical or asymmetrical. According to various embodiments, the extraction features may be patterned in a suitable density so as to produce a substantially uniform illumination. For instance, the density of the light extraction features may vary along the length of the glass article (e.g., light guide plate), such as having a first density at a light-incident side of the article, with an increasing or decreasing density at various points along the length of the article.

In non-limiting embodiments, the glass article can be further processed before and/or after laser damaging and etching the first or second surface. For example, the glass article may be ground and/or polished to achieve the desired thickness and/or surface quality. The glass may also be optionally cleaned and/or the surface of the glass may be subjected to a process for removing contamination, such as exposing the surface to ozone or other cleaning agents.

The glass may also be chemically strengthened, e.g., by ion exchange. During the ion exchange process, ions within a glass sheet at or near the surface of the glass article may be exchanged for larger metal ions, for example, from a salt bath. The incorporation of the larger ions into the glass can strengthen the article by creating a compressive stress in a near surface region. A corresponding tensile stress can be induced within a central region of the glass sheet to balance the compressive stress.

Ion exchange may be carried out, for example, by immersing the glass in a molten salt bath for a predetermined period of time. Exemplary salt baths include, but are not limited to, KNO₃, LiNO₃, NaNO₃, RbNO₃, and combinations thereof. The temperature of the molten salt bath and treatment time period can vary. It is within the ability of one skilled in the art to determine the time and temperature according to the desired application. By way of a non-limiting example, the temperature of the molten salt bath may range from about 400° C. to about 800° C., such as from about 400° C. to about 500° C., and the predetermined time period may range from about 4 to about 24 hours, such as from about 4 hours to about 10 hours, although other temperature and time combinations are envisioned. By way of a non-limiting example, the glass can be submerged in a KNO₃ bath, for example, at about 450° C. for about 6 hours to obtain a K-enriched layer which imparts a surface compressive stress.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a light source” includes examples having two or more such light sources unless the context clearly indicates otherwise. Likewise, a “plurality” is intended to denote “more than one.” As such, a “plurality of light extraction features” includes two or more such features, such as three or more such features, etc.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Examples are intended to be non-restrictive and illustrative only, with the scope of the invention being defined by the claims.

### EXAMPLES

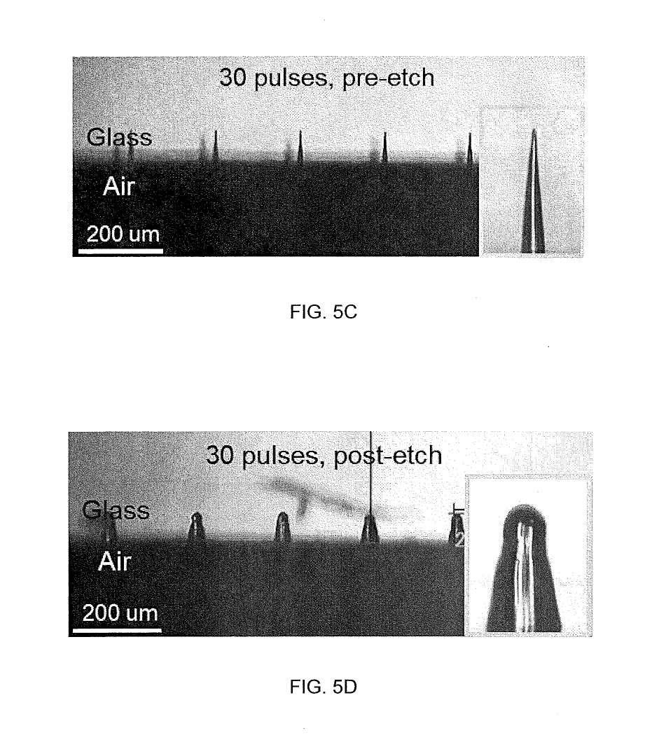

A pulsed Nd:YVO4 laser operating at a wavelength of about 355 nm and focused to an approximately 6 micron diameter (1/e²) spot was brought into contact with a glass substrate. The pulse width of the laser was about 30 nsec, the pulse repetition rate (frequency) was 5 kHz, and the pulse energy was 85 μJ. Light extraction features were created on a surface of the glass substrate using either 5 or 30 laser pulses. FIG. 5A is a side view of a glass substrate with extraction features created using 5 laser pulses (including an expanded view of a single feature, not to scale). The 5-pulse features had a diameter of about 8 microns and a depth of about 11 microns. FIG. 5C is a side view of a glass substrate with extraction features created using 30 laser pulses (including an expanded view of a single feature, not to scale). The 30-pulse features had a diameter of about 15 microns and a depth of about 70 microns.

After laser exposure, the glass substrates were etched in an acid bath comprising 5% HF and 10% HNO₃ by volume for 9 minutes. The etching rate was about 3.8 microns per minute. A 40 kHz ultrasonic agitation was used with bath recirculation and mechanical agitation to ensure an even etching rate across the sample.

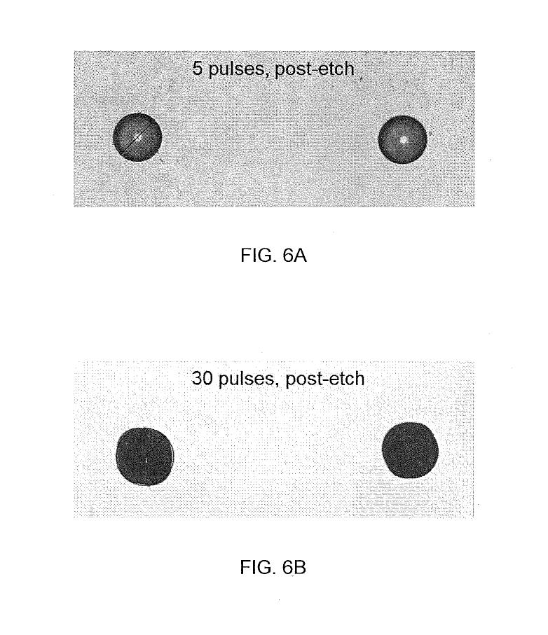

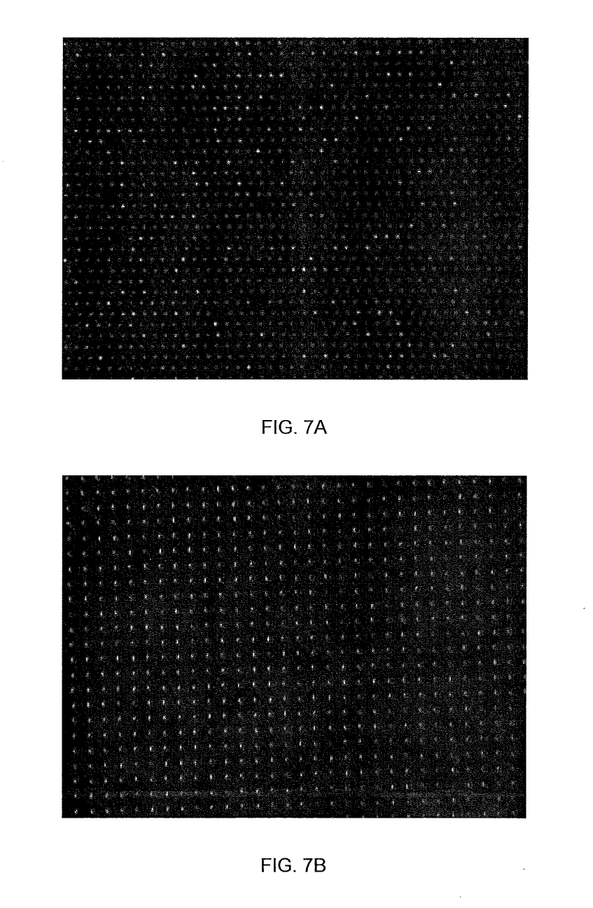

FIG. 5B is a side view of the 5-pulse glass substrate after etching, with features having a diameter of 36 microns and a depth of 11 microns. Similarly, FIG. 5D is a side view of the 30-pulse glass substrate after etching, with features having a diameter of 43 microns and a depth of 63 microns. FIGS. 6A-B are top views of the 5-pulse and 30-pulse features, respectively, illustrating that each feature has a substantially clean edge and surrounding area (e.g., substantially free of debris and/or defects). As a result, the glass substrates may exhibit good light extraction efficiency with a high degree of uniformity across the substrate. Referring to FIGS. 7A-B, which are top views of a laser exposed glass substrate before and after etching (feature pitch=500 microns), it can be observed that the etched substrate (FIG. 7B) is noticeably more homogenous than the non-etched substrate (FIG. 7A), which shows significant amounts of noise, as indicated by a wide variety of brightness or intensity across the features (some very bright and some very dark spots). As exhibited in FIGS. 5B, 5D, 6A, 6B, 7A and 7B, exemplary laser plus etching processes described above can be provided and modified as appropriate to generate a desired or predetermined geometry, diameter/depth/thickness ratio, etc. and/or to remove any irregularities encountered during laser damaging or to achieve optimal light extraction features.

1. A method for making a glass article comprising:
contacting a first surface of a glass substrate with a laser to produce a first plurality of light extraction features having a first diameter and a first depth; and
etching the glass substrate to form a second plurality of light extraction features having a second diameter and a second depth.

2. The method of claim 1, wherein the first, second, or both the first and second plurality of light extraction features are present on the first surface in a random, arranged, repetitive, non-repetitive, symmetrical, or asymmetrical pattern.

3. The method of claim 1, wherein the second diameter of the second light extraction features ranges from about 5 microns to about 1 mm.

4. The method of claim 1, wherein the second diameter of the second light extraction features ranges from about 20 microns to about 50 microns.

5. The method of claim 1, wherein the second diameter of the second light extraction features is greater than the first diameter of the first light extraction features.

6. The method of claim 1, wherein the second depth of the second light extraction features ranges from about 1 micron to about 3 mm.

7. The method of claim 1, wherein the second depth of the second light extraction features ranges from about 10 microns to about 200 microns.

8. The method of claim 1, wherein the second depth of the second light extraction features is greater than or equal to the first depth of the first light extraction features.

9. The method of claim 1, wherein the plurality of second light extraction features comprise a depth to diameter ratio ranging from about 1:1 to about 10:1.

10. The method of claim 1, wherein the distance between the second light extraction features ranges from about 5 microns to about 2 mm.

11. The method of claim 1, wherein any one or combination of the depths, diameters, ratio of depth to diameter, and geometries of the second light extraction features vary as a function of position on the first surface.

12. The method of claim 1, further comprising forming a third plurality of light extraction features on an opposing second surface of the glass substrate.

13. The method of claim 1, wherein the laser is chosen from CO₂ lasers, yttrium aluminum garnet (YAG) lasers, frequency tripled neodymium-doped YAG (Nd:YAG) lasers, and frequency tripled neodymium-doped yttrium orthovanadate (Nd:YVO4) lasers.

14. The method of claim 1, wherein the laser operates at a wavelength ranging from about 200 nm to about 3 microns.

15. The method of claim 1, wherein etching comprises contacting the glass substrate with at least one etching agent.

16. The method of claim 1, wherein etching comprises immersing the glass substrate in an acid bath for a period of time ranging from about 30 seconds to about 15 minutes.

17. The method of claim 15, wherein the at least one etching agent is chosen from mineral acids.

18. A glass article comprising a first surface and an opposing second surface;
wherein the first surface comprises a plurality of light extraction features having a diameter ranging from about 5 microns to about 1 mm and a depth ranging from about 1 micron to about 3 mm, and wherein a distribution of light extraction efficiency of the plurality of light extraction features has a 1σ value of at least about 0.4.

19. The glass article of claim 18, wherein the 1σ value is at least about 0.45.

20. The glass article of claim 18, wherein the light extraction features are concave, ellipsoidal, paraboloidal, hyperboloidal, or frusto-conical.

21. The glass article of claim 18, wherein the plurality of light extraction features is present on the first surface in a random, arranged, repetitive, non-repetitive, symmetrical, or asymmetrical pattern.

22. The glass article of claim 18, wherein the diameter of the light extraction features ranges from about 10 microns to about 250 microns.

23. The glass article of claim 18, wherein the diameter of the light extraction features ranges from about 20 microns to about 50 microns.

24. The glass article of claim 18, wherein the depth of the light extraction features ranges from about 10 microns to about 200 microns.

25. The glass article of claim 18, wherein the light extraction features comprise a depth to diameter ratio ranging from about 1:1 to about 10:1.

26. The glass article of claim 18, wherein the distance between the light extraction features ranges from about 5 microns to about 2 mm.

27. The glass article of claim 18, wherein a thickness of the glass article ranges from about 0.3 mm to about 3 mm.

28. The glass article of claim 18, wherein any one or combination of the depths, diameters, ratio of depth to diameter, and geometries of the light extraction features vary as a function of position on the first surface.

29. The glass article of claim 18, wherein the opposing second surface comprises a second plurality of light extraction features.

30. A display device or luminaire comprising the glass article of claim 1.
